(19) United States
(12) Patent Application Publication
(10) Pub. No.: US 2023/0092627 A1
(43) Pub. Date: Mar. 23, 2023

(54) DISTRIBUTED SENSING AND CLASSIFICATION

(71) Applicant: International Business Machines Corporation, Armonk, NY (US)

(72) Inventors: Abbas Rahimi, Zurich (CH); Abu Sebastian, Adliswil (CH)

(21) Appl. No.: 17/481,298

(22) Filed: Sep. 21, 2021

(51) Int. Cl. G06F 30/20; G06K 9/62; G06N 3/00

(52) U.S. Cl. CPC G06F 30/20; G06K 9/6232; G06K 9/6289; G06N 3/002; G06F 2111/06

(57) ABSTRACT

The invention is notably directed to a sensor system for performing distributed sensing and classification of sensor data. The sensor system comprises a set of distributed sensor nodes for sensing the sensor data. The sensor system is configured to encode the sensor data of each sensor node of a set of distributed sensor nodes for sensing the sensor data as high-dimensional vectors and to transmit the high-dimensional vectors over a respective link between the respective sensor node and a receiver system. The sensor system is further configured to superpose the high-dimensional vectors of the sensor data from the set of sensor nodes by physical superposition, thereby generating a superposed high-dimensional vector and to classify the superposed high-dimensional vectors at the receiver system.

### BACKGROUND

Aspects of the present disclosure relate to a sensor system for performing distributed sensing and classification of sensor data.

The disclosure further concerns a related method and a related computer program product.

High-dimensional (HD) computing is a brain-inspired non von Neumann computing paradigm based on representing information with high-dimensional vectors (thousands of dimensions). HD vectors are holographic and (pseudo)random with independent and identically distributed (i.i.d.) components. HD operations (addition, multiplication, and permutation) form a mathematical structure (e.g., one using the concepts of algebra, such as linear algebra) over the space of HD vectors. HD computing uses these operations to manipulate the atomic vectors for cognitive and machine learning tasks.

### BRIEF SUMMARY

Aspects of the disclosure are related to a sensor system for performing distributed sensing and classification of sensor data. The sensor system comprises a set of distributed sensor nodes for sensing the sensor data. The sensor system is configured to encode the sensor data of each sensor node of the set of distributed sensor nodes for sensing the sensor data as high-dimensional vectors and to transmit the high-dimensional vectors over a respective link between the respective sensor node and a receiver system. The sensor system is further configured to superpose the high-dimensional vectors of the sensor data from the set of sensor nodes by physical superposition, thereby generating a superposed high-dimensional vector and to classify the superposed high-dimensional vectors at the receiver system.

According to an embodiment of another aspect of the invention, a computer-implemented method for distributed sensing and classification of sensor data is provided. The sensor data is provided/sensed by a set of distributed sensor nodes. The method comprises steps of encoding the sensor data of each sensor node of a set of distributed sensor nodes as high-dimensional vectors, transmitting the high-dimensional vectors over a respective link between the respective sensor node and a receiver system and superposing the high-dimensional vectors of the sensor data from the set of sensor nodes by physical superposition, thereby generating a superposed high-dimensional vector. The method comprises a further step of classifying the superposed high-dimensional vectors at the receiver system.

According to an embodiment of another aspect of the invention, a computer program product for operating a sensor system for distributed sensing and classification of sensor data is provided. The computer program product comprises a computer readable storage medium having program instructions embodied therewith, the program instructions executable by the sensor system to cause sensor system to perform a method comprising steps of encoding the sensor data of each sensor node of the a set of distributed sensor nodes for sensing the sensor data as high-dimensional vectors, transmitting the high-dimensional vectors over a respective link between the respective sensor node and a receiver system and superposing the high-dimensional vectors of the sensor data from the set of sensor nodes by physical superposition, thereby generating a superposed high-dimensional vector. The method comprises further a step of classifying the superposed high-dimensional vectors at the receiver system.

Embodiments of the invention will be described in more detail below, by way of illustrative and non-limiting examples, with reference to the accompanying drawings.

### BRIEF DESCRIPTION OF THE DRAWINGS

FIG. 1 is a simplified schematic block diagram of a sensor system for performing distributed sensing and classification of sensor data;

FIG. 2 shows a high-dimensional encoder according to an embodiment of the invention;

FIG. 3 shows a high-dimensional encoder according to an embodiment of the invention;

FIG. 4 shows a more detailed embodiment of a classifier of FIG. 1;

FIG. 5 shows a flow chart of a computer-implemented method for distributed sensing and classification of sensor data according to an embodiment of the invention; and

FIG. 6a shows simulation results of a method for distributed sensing and classification of sensor data by means of high-dimensional vectors, wherein each of the high-dimensional vectors comprise 256 bits;

FIG. 6b shows simulation results of a method for distributed sensing and classification of sensor data according to an embodiment of the invention, wherein each of the high-dimensional vectors comprise 512 bits;

FIG. 6c shows simulation results of a method for distributed sensing and classification of sensor data according to an embodiment of the invention, wherein each of the high-dimensional vectors comprise 4096 bits; and

FIG. 6d shows simulation results of a method for distributed sensing and classification of sensor data according to an embodiment of the invention, wherein each of the high-dimensional vectors comprise 8192 bits.

### DETAILED DESCRIPTION

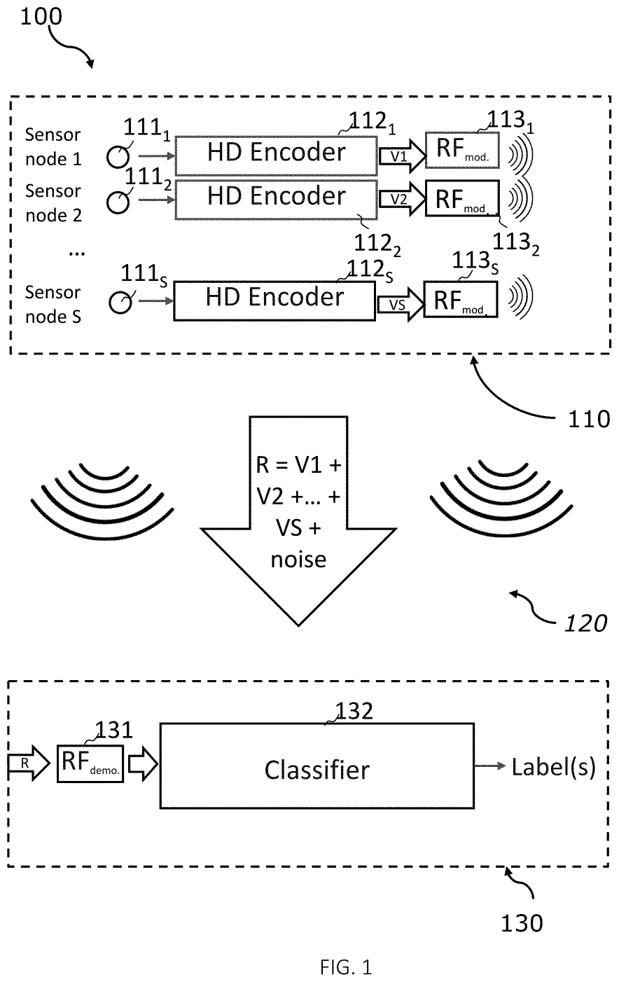

In reference to FIGS. 1-6d, some general aspects and terms of embodiments of the invention are described.

High-dimensional (HD) computing is a brain-inspired non von Neumann machine learning model based on representing information with high-dimensional vectors. A processor based on HD computing may be seen as an extremely wide dataflow processor with a small instruction set of bit-level operations.

High-dimensional computing represents information by projecting data onto vectors in a high-dimensional space. HD vectors may be in particular embodied holographic and (pseudo)random with independent and identically distributed (i.i.d.) components. High-dimensional computing may also be denoted as hyperdimensional computing. High-dimensional vectors may also be denoted as hypervectors. According to embodiments, the high-dimensional vectors/hypervectors may have dimensions of more than 100 elements, of more than 1000 elements or of more than 10000 elements.

HD vectors are very tolerant to noise, variations, or faulty components due to their redundant i.i.d. representation, in which information symbols are spread holographically across many components. This makes HD computing a prime candidate for implementation on emerging nanoscale fabrics operating at low signal-to-noise (SNR) conditions.

Furthermore, the robustness of HD vectors may be used in low SNR communication channels, allowing higher error tolerance with increased dimensionality.

HD computing may be used for manipulating and comparing large patterns within a memory. A processor based on HD computing may be seen as an extremely wide dataflow processor with a small instruction set of bit-level operations. For learning and inference tasks, the HD processor is composed of two main modules: encoding, and associative memory (or distance computation).

HD computing has also been proposed for bio-signal processing such as electromyography (EMG) signals. Such signals comprise a set of parallel analog input signals, e.g. EMG-signals. The input signals are taken from different EMG sensors which are distributed over the body of a patient.

An associative memory module may be defined as a memory module which is configured to compare input data, in particular query hypervectors, with data stored in the associative memory module, in particular with stored profile hypervectors. An associative memory module may be also denoted as content-addressable memory (CAM) or as associative storage.

A system according to embodiments of the disclosure may comprise a set of high-dimensional encoders and an associative memory. In the associative memory, the distance computation may be performed in a distributed fashion.

According to embodiments of the disclosure, the associative memory may comprise a plurality of resistive elements. The plurality of resistive elements may be, in particular, arranged in a crossbar array.

According to embodiments, the associative memory may comprise one or more planar crossbar arrays. The one or more planar crossbar arrays may comprise a plurality of resistive memory elements. The receiver system according to embodiments may be configured to program profile/prototype vector elements of profile/prototype hypervectors as conductance states of the resistive memory elements and to apply query vector elements of query hypervectors as read voltages to the one or more crossbar arrays. The receiver system may be further configured to perform a distance computation between the profile hypervectors and the query hypervectors by measuring output current signals of the one or more crossbar arrays.

A resistive element may be defined as an element which comprises a resistive material and whose electrical resistance can be changed by applying an electrical programming signal to the resistive element. The resistive element may be in particular embodied as a resistive memory element. The electrical programming signal may be e.g. a current flowing through the resistive memory element, or an electrical voltage applied to the resistive memory element. The current and/or voltage may be e.g. applied to the resistive memory element in the form of pulses. As a result, the electrical resistance of a resistive memory element depends on the history of current that had previously flown through the memory element and/or the history of the electric signal that had been applied to the resistive memory element.

Resistive memory elements are based on a physical phenomenon occurring in a material that changes its resistance under action of a current or electric field. The change is usually non-volatile and reversible. Several classes of resistive memory elements are known, ranging from metal oxides to chalcogenides. Typical resistive memory elements are metal/insulator/metal structures where the metallic components serve as the electrodes and the insulator is a resistive switching material, e.g. a chalcogenide. These resistive memory elements exhibit good performance in terms of power consumption, integration density potential, retention, and endurance.

According to embodiments, the system may be in particular configured to sense and process quantitative data signals. Quantitative data signals are measures of values or counts and are expressed as numbers. Quantitative data is data about numeric variables. Qualitative data is measurements of ‘types’ and may be represented by a name, symbol, or a number code.

According to embodiments quantitative data signals may be in particular biopotential signals or electrophysiological signals, also denoted as ExG signals. Such electrophysiological signals encompass EMG (electromyography) signals, EEG (electroencephalography) signals and ECG (electrocardiography) signals.

Referring at first to FIG. 1, a high-level schematic block diagram of a sensor system 100 for performing distributed sensing and classification of sensor data is shown. The sensor system 100 comprises a transmitter system 110, a receiver system 130 and a transmission channel 120 between the transmitter system 110 and the receiver system 130. The transmitter system 110 comprises a plurality of sensor nodes, which are collectively referred to as sensor nodes 111. More particularly, the transmitter system 110 comprises a number S of sensor nodes 111₁ to 111s, wherein S is an integer. The sensor nodes 111 are distributed and disjoint, i.e. locally displaced or in other words spaced apart from each other. The sensor nodes 111 may be e.g. ExG nodes which are distributed over the body of a patient.

Each sensor node 111 comprises or in other words is coupled to a corresponding high-dimensional encoder 112. More particularly, the transmitter system 110 comprises a number S of high-dimensional encoder nodes 112₁ to 112s corresponding to the S sensor nodes 111₁ to 111s. The high-dimensional encoders 112 are configured to receive the sensor data, e.g. the ExG-signal and to encode the sensor data as high-dimensional vectors V1, V2, . . . VS. The high-dimensional vectors V1, V2, . . . VS may be in particular embodied as unique quasi-orthogonal high-dimensional vectors. According to embodiments, the high-dimensional encoders 112 are configured to assign a unique quasi-orthogonal high-dimensional vector to every possible input combination of the sensor data. Hence at every sensor node there is a single high-dimensional encoding step to encode sensor information into a unique high-dimensional vector. Furthermore, each high-dimensional encoder 112 is randomly initialized such that its transmitted high-dimensional vector is unrelated (quasi-orthogonal) to other sensor nodes even if the sensor data is the same. According to embodiments, no channel encoding is involved.

The transmitter system 110 further comprises for each sensor node and each associated high-dimensional encoder a corresponding RF-transmitter 113, which may be also denoted as a RFmod. More particularly, the transmitter system 110 comprises a number S of RF-transmitters 113₁ to 113s corresponding to the S sensor nodes 111₁ to 111s and the S high-dimensional encoder nodes 112₁ to 112s.

The RF-transmitters 113 are configured to transmit the high-dimensional vectors simultaneously via the transmission channel 120 over a respective link between the respective sensor node and the receiver system. The RF-transmitters 113₁ to 113s may perform a physical modulation of the high-dimensional vectors V1, V2, . . . VS onto a high-frequency carrier signal. According to embodiments, amplitude modulation (AM), frequency modulation (FM) or phase modulation (PM) may be used. In some embodiments, a link may be a physical link, an optical link, a wireless link, etc.

The high-dimensional vectors V1, V2, . . . VS are superposed, i.e. added, in the transmission channel 120 or in other words by the transmission channel 120 by physical superposition or in other words by using physical superposition principle, e.g. in the air. This generates a superposed high-dimensional vector R=V1+V2+VS. Such a component-wise addition preserves the dimensionality of the high-dimensional vectors.

The receiver system 130 is configured to receive the superposed high-dimensional vector R. More particularly, the receiver system 130 receives the superposed high-dimensional vector plus noise.

The receiver system 130 comprises an RF-receiver 131, which may also be denoted as RF_{demo}. The RF-receiver 131 is in particular configured to perform a demodulation of the received RF-signal comprising the superposed high-dimensional vector R.

The receiver system 130 further comprises a classifier 132 which is configured to receive the demodulated high-dimensional vector R and to classify the high-dimensional vector R. Before performing a classification, the classifier 132 is configured to be trained with appropriate training data. The classifier 132 delivers as output signal classification data, e.g. a respective label for the respective high-dimensional vector R.

The receiver system 130 performs directly a classification, e.g. by using an associative memory or multiple associative memories. According to embodiments, no channel decoding is involved.

According to embodiments, the classifier 132 may be programmed during a training phase with superposed prototype high-dimensional vectors/prototype hypervectors. According to embodiments, during an inference phase superposed query high-dimensional vectors/query hypervectors may be applied to the classifier 132. The classifier 132 may be configured to perform a distance computation between the superposed prototype high-dimensional vectors and the query high-dimensional vectors in order to perform the classification.

According to an embodiment, the device may be configured to perform similarity computation as a dot-product computation.

According to embodiments, the sensor system is configured to transmit the high-dimensional vectors via single path propagation. According to other embodiments, the system is configured to transmit the high-dimensional vectors via multi-path propagation.

According to such an embodiment, the receiver system 130 may be configured to perform a permutation operation on the high-dimensional vectors received via the multi-path propagation. By this, the received high-dimensional vectors may be aligned according to the longest path delay. For such an embodiment, the receiver system 130 is trained beforehand with training data/training vectors to learn the respective number of permutations which is needed for the respective transmission channel 120 to compensate for the multi-path propagation.

According to embodiments the transmission channel may be a wireless transmission channel or an optical transmission channel. Accordingly, the high-dimensional vectors may be transmitted via physical wireless links, physical optical links or conventional electrical links between the transmitter system 110 and the receiver system 130. In general, the transmission channel 120 may be embodied by any link that allows transmission and superposition of the high-dimensional vectors between the transmitter system 110 and the receiver system 130.

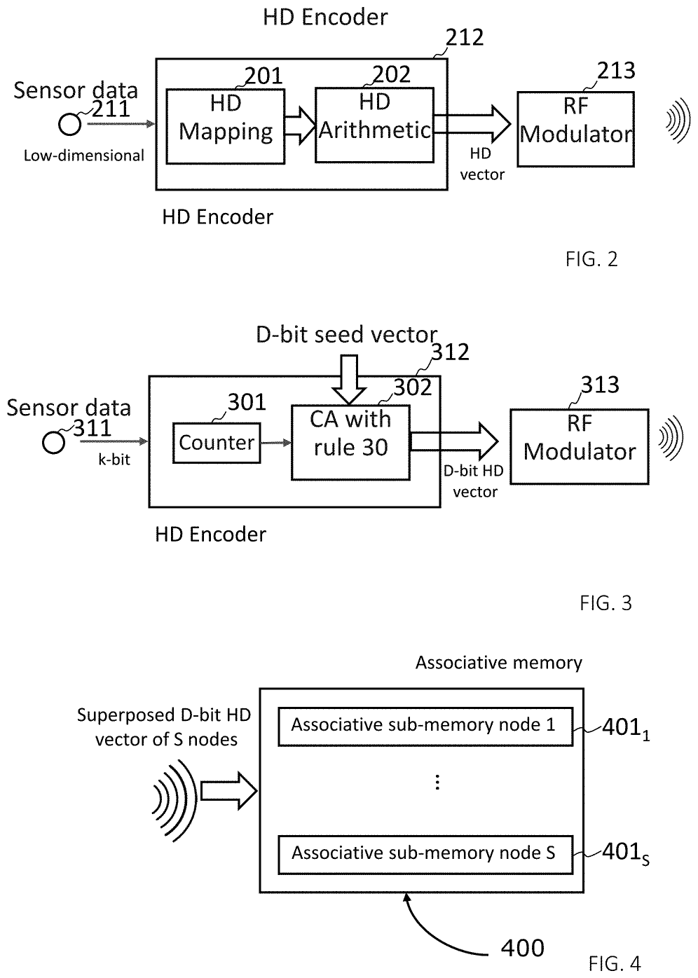

FIG. 2 shows a high-dimensional encoder 212 according to an embodiment of the invention. The high-dimensional encoder 212 may represent a more detailed embodiment of the high-dimensional encoders 112₁ . . . 112s of FIG. 1.

The high-dimensional encoder 212 is configured to receive sensor data, in particular low-dimensional sensor data, from a sensor node 211. The high-dimensional encoder 212 comprises a unit 201 which is configured to encode the low dimensional sensor data as a unique quasi-orthogonal high-dimensional vector.

According to embodiments the high-dimensional encoder 212 may further comprise a unit 202 for performing one or more arithmetic operations on the high-dimensional vector.

The high-dimensional vector is then forwarded to a RF-transmitter 213 for transmitting the high-dimensional vector over a corresponding transmission channel to a corresponding receiver system, e.g. the receiver system 130 of FIG. 1.

FIG. 3 shows a high-dimensional encoder 312 according to an embodiment of the invention. The high-dimensional encoder 312 may represent a more detailed embodiment of the high-dimensional encoders 112₁ . . . 112s of FIG. 1.

The high-dimensional encoder 312 is configured to receive sensor data, in particular k-bit sensor data, from a sensor node 311, wherein k is an integer. The high-dimensional encoder 312 is configured to be randomly initialized by a D-bit seed vector such that its corresponding encoded high-dimensional vectors are quasi-orthogonal to the encoded high-dimensional vectors of the other sensor nodes, wherein D is an integer (e.g., an integer that represents the various dimensions of the high-dimensional encoder 312). The high-dimensional encoder 312 is configured to generate a D-bit high-dimensional vector. More particularly, based on the seed vector, the high-dimensional encoder 312 assigns a unique quasi-orthogonal HD vector to every possible combinations of inputs such as information bits, states, events, etc.

According to embodiments, the high-dimensional encoder 312 may comprise a cellular automaton 302, in particular a rule 30 automaton. According to such an embodiment, the D-dimensional cellular automaton is initialized by a seed vector and applies rule 30 from 0 to 2^{K}-1 cycles. According to such an embodiment the high-dimensional encoder 312 further comprises a counter 301. The counter 301 receives the k-bit sensor data as an input signal and transforms the k-bit sensor data into a corresponding count value. The count value is then transmitted as a control signal to the cellular automaton 302 which transforms the count value into a corresponding D-bit high-dimensional vector.

According to other embodiments, a memorizing cellular automaton with a large item memory (2K) that assigns a random dense binary vector to possible inputs that may be used.

According to other embodiments, a smaller item memory with HD arithmetic (multiplication and permutation) to enforce the quasi-orthogonality of generated vectors such as an n-gram encoder may be used.

The high-dimensional vector is then forwarded to a RF-transmitter 313 for transmitting the high-dimensional vector over a corresponding transmission channel to a corresponding receiver system, e.g. the receiver system 130 of FIG. 1.

According to embodiments, the high dimensional encoder may operate at various dimensions D, subject to its capacity and desired robustness.

The sensor system 100 may be in particular configured to transmit the D-bit high-dimensional vectors directly without any further encoding, parity and/or transformation via the transmission channel 120 to the receiving system 130.

FIG. 4 shows a more detailed embodiment of the classifier 132 of FIG. 1. More particularly, the classifier 132 may be embodied as associative memory 400. The associative memory 400 may be in particular embodied to directly classify the sensor data, i.e. without channel decoding.

According to embodiments, the associative memory 400 comprises for each sensor node, e.g. for each sensor node 111₁, . . . , 111s of FIG. 1, a separate associative sub-memory 401₁, . . . , 401s.

According to embodiments, the associative memory 400 is configured to receive the superposed D-bit high dimensional vectors of the S nodes and to classify them by a single pass, i.e. with no iterations and no decoding.

According to embodiments, the associative memory 400 may be trained without considering noise on the links as well as with considering noise on the links between the sensor nodes and the receiver system.

In the noise-less scenario, the associative memory 400 may be trained ahead of communication time without considering additive white Gaussian noise (AWGN) in the transmission channel. In the noisy scenario, the associative memory 400 can consider the manifestation of AWGN, or any other noise and non-linearity, in the transmission channel and train prototype vectors accordingly.

According to embodiments, the receiver system 130 can jointly train the associative memory 400 or individually train the S parallel associative sub-memories. For example, S×2K prototype vectors may be used in the associative memory to detect the individual labels of all sensing nodes when every sensor sensed k-bit of information.

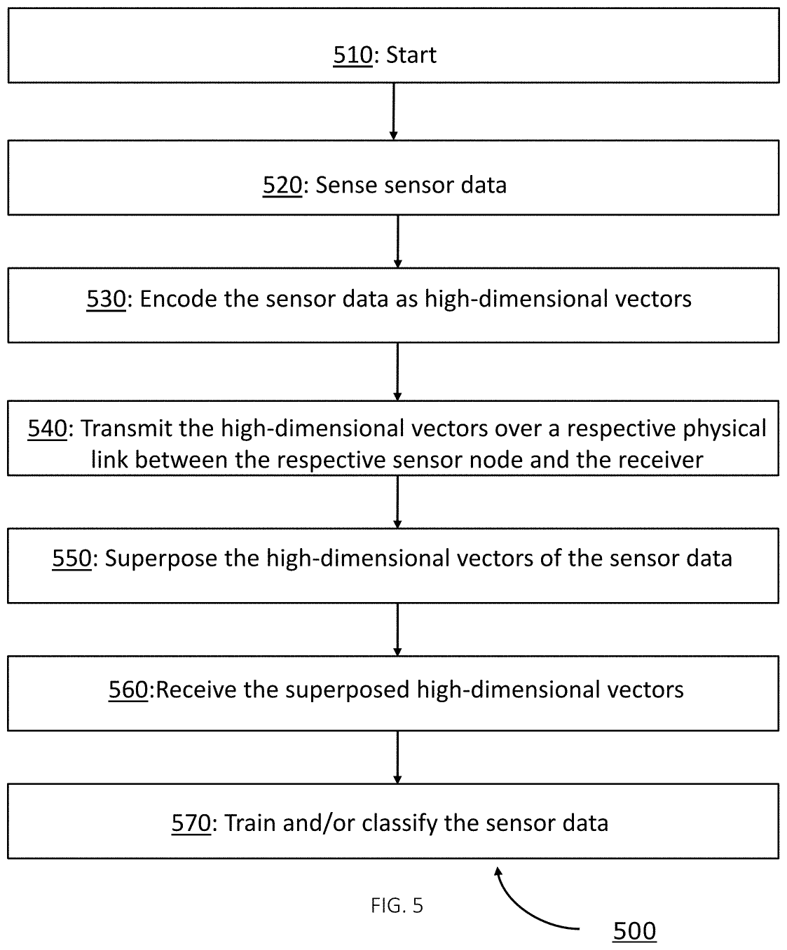

FIG. 5 shows a flow chart of a computer-implemented method for distributed sensing and classification of sensor data according to an embodiment of the invention. The method may be performed e.g. by the sensor system 100 as shown in FIG. 1. Hence in the following it is referred to the components of FIG. 1.

At a step 510, the method 500 starts.

At a step 520, the sensor nodes 111 sense the sensor data.

At a step 530, the sensor data of each sensor node 111 of the set of sensor nodes is encoded as a high-dimensional vector, e.g. by the high-dimensional encoders 112.

At a step 540, the high-dimensional vectors are transmitted from the transmitter system 110 to the receiver system 130 over respective links of the transmission channel 120 and thereby, at a step 550 superposed by e.g. physical superposition. The physical superposition has generated a superposed high-dimensional vector.

At a step 560, the superposed high-dimensional vectors are received at the receiver system 130.

At a step 570, the sensor data may be used for training or classification.

In other words, the step 570 may encompass a training phase and/or an inference phase.

In the training phase, the classifier 132, in particular the associative memory 400, may be trained. In such a training phase the high-dimensional vectors and the superposed high-dimensional vectors may be known vectors of a training set in order to train the classifier 132.

Then, in the subsequent inference phase, the trained classifier may be used to classify (unknown) sensor data and the corresponding high-dimensional vectors at the receiver system 130.

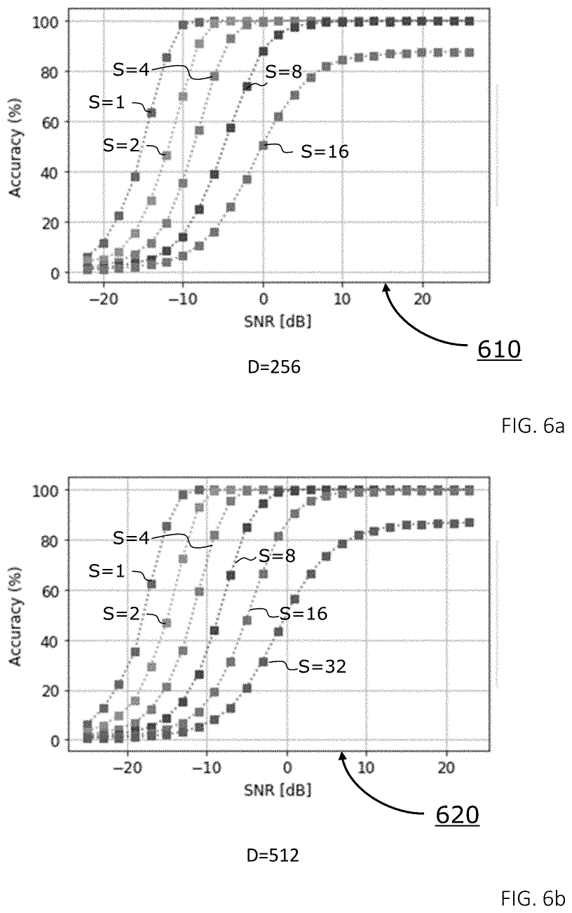

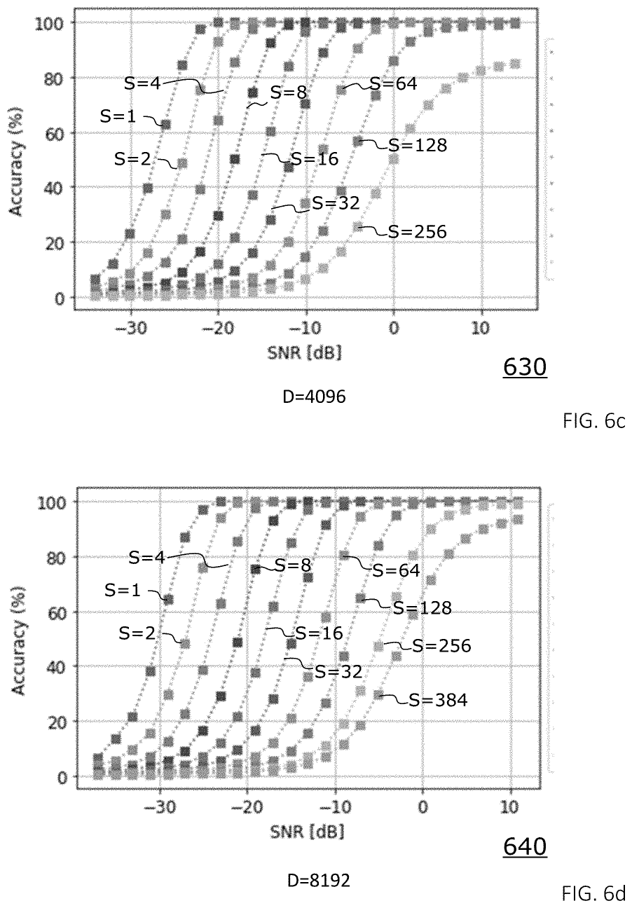

FIGS. 6a to 6d shows simulation results 610, 620, 630, and 640 of a method for distributed sensing and classification of sensor data according to an embodiment of the invention. The vertical y-axis denotes the accuracy of the classification in % and the horizontal x-axis the Signal-to-Noise-Ratio (SNR) in dB. The number of input bits k was chosen as k=8 for every sensor node. More particularly, SNR is defined as the ratio of the power of encoded D-bit vectors to the power of the background noise (unwanted D-dimensional vectors).

FIG. 6a shows 5 graph lines for a number S of sensor nodes, wherein S=1, 2, 4, 8 and 16. According to the embodiment of FIG. 6a, it was assumed that each of the high-dimensional vectors comprise D-bits, wherein D=256. As can be seen in FIG. 6a, the embodiment easily supports up to 4 nodes at negative SNR and achieves 100% accuracy up to 8 nodes at positive SNR.

FIG. 6b shows 6 graph lines for a number S of sensor nodes, wherein S=1, 2, 4, 8, 16 and 32.

According to the embodiment of FIG. 6b, it was assumed that each of the high-dimensional vectors comprise D-bits, wherein D=512. As can be seen in FIG. 6b, the embodiment easily supports up to 8 nodes at negative SNR and achieves 100% accuracy up to 16 nodes at positive SNR.

FIG. 6c shows 9 graph lines for a number S of sensor nodes, wherein S=1, 2, 4, 8, 16, 32, 64, 128 and 256. According to the embodiment of FIG. 6c, it was assumed that each of the high-dimensional vectors comprise D-bits, wherein D=4096. As can be seen in FIG. 6c, the embodiment easily supports up to 64 nodes at negative SNR and achieves 100% accuracy up to 128 nodes at positive SNR.

FIG. 6d shows 10 graph lines for a number S of sensor nodes, wherein S=1, 2, 4, 8, 16, 32, 64, 128, 256 and 384. According to the embodiment of FIG. 6d, it was assumed that each of the high-dimensional vectors comprise D-bits, wherein D=8192. As can be seen in FIG. 6d, the embodiment easily supports up to 128 nodes at negative SNR and achieves 100% accuracy up to 256 nodes at positive SNR.

As a result or summary of FIGS. 6a to 6d, it can be derived that the maximum number of nodes (S) for a reliable classification will linearly increase by the dimension of the transmitted high-dimensional vector (D).

The above presented sensor systems and methods according to embodiments of the invention may provide in particular advantages as follows.

According to embodiments, all sensor nodes collectively play a role in the classification event. Furthermore, transformations between different representations is avoided as well as the overhead of multiple layers of encoding/decoding. This reduces the latency and complexity of the sensors system according to embodiments of the invention.

Furthermore, methods according to embodiments of the invention are scalable. More particularly, the number of sensor nodes can be linearly increased by the dimension of the high-dimensional vector.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In general, modifications described for one embodiment may be applied to another embodiment as appropriate.

What is claimed is:

1. A sensor system for performing distributed sensing and classification of sensor data, the sensor system being configured to:
encode the sensor data of each sensor node of a set of distributed sensor nodes for sensing the sensor data as high-dimensional vectors;
transmit the high-dimensional vectors over a respective link between a sensor node and a receiver system;
superpose the high-dimensional vectors of the sensor data from the set of sensor nodes by physical superposition, thereby generating a superposed high-dimensional vector; and
classify the superposed high-dimensional vectors by the receiver system.

2. A sensor system according to claim 1, the sensor system being configured to encode the sensor data of each sensor node of the set of sensor nodes as a unique quasi-orthogonal high-dimensional vector.

3. A sensor system according to claim 1, wherein the receiver system comprises an associative memory, the associative memory being configured to directly classify the superposed high-dimensional vectors.

4. A sensor system according to claim 1, wherein each sensor node comprises a corresponding high-dimensional encoder, the high dimensional encoder being configured to encode the sensor data by assigning a unique quasi-orthogonal high-dimensional vector to possible combinations of the sensor data.

5. A sensor system according to claim 4, wherein each high-dimensional encoder is configured to be randomly initialized such that its corresponding encoded high-dimensional vectors are quasi-orthogonal to the encoded high-dimensional vectors of one or more other sensor nodes.

6. A sensor system according to claim 4, wherein;
each high-dimensional encoder is configured to generate a D-bit high-dimensional vector; and
the sensor system is configured to transmit the D-bit high-dimensional vector directly without any further encoding, parity, and transformation.

7. A sensor system according to claim 4, wherein;
each high-dimensional encoder is embodied as a cellular automaton.

8. A sensor system according to claim 7, wherein;
the cellular automaton is a rule 30 automaton.

9. A sensor system according to claim 1, wherein the sensor system is configured to transmit the high-dimensional vectors via single path propagation.

10. A sensor system according to claim 1, wherein the sensor system is configured to transmit the high-dimensional vectors via multi-path propagation, wherein the receiver system is configured to perform a permutation operation on the high-dimensional vectors received via the multi-path propagation to align the received high-dimensional vectors.

11. A sensor system according to claim 1, wherein the links are selected from a group consisting of wireless links, optical links and electrical links.

12. A sensor system according to claim 3, wherein the associative memory comprises for each sensor node a separate associative sub-memory.

13. A sensor system according to claim 3, wherein the associative memory is configured to classify the received high-dimensional vectors by a single pass.

14. A sensor system according to claim 3, wherein the associative memory is configured to be trained without considering noise on the links as well as with considering noise on the links between the sensor nodes and the receiver system.

15. A computer-implemented method for distributed sensing and classification of sensor data, the method comprising:
encoding the sensor data of each sensor node of the a set of distributed sensor nodes for sensing the sensor data as high-dimensional vectors;
transmitting the high-dimensional vectors over a respective link between a sensor node and a receiver system;
superposing the high-dimensional vectors of the sensor data from the set of sensor nodes by physical superposition, thereby generating a superposed high-dimensional vector; and
classifying the superposed high-dimensional vectors by the receiver system.

16. A computer-implemented method according to claim 15, further comprising;
encoding the sensor data of each sensor node of the set of sensor nodes as a unique quasi-orthogonal high-dimensional vector.

17. A computer-implemented method according to claim 15, further comprising;
directly classifying the superposed high-dimensional vectors by an associative memory of the receiver system.

18. A computer-implemented method according to claim 15, further comprising;
generating a D-bit high-dimensional vector for the sensor data of each sensor node; and
transmitting the D-bit high-dimensional vector directly without any further encoding, parity, and transformation via the respective link.

19. A computer-implemented method according to claim 17, further comprising;
training the associative memory without considering noise on the links and with considering noise on the links.

20. A computer program product for operating a sensor system for distributed sensing and classification of sensor data, the computer program product comprising a computer readable storage medium having program instructions embodied therewith, the program instructions executable by the sensor system to cause the sensor system to perform a method comprising:
encoding the sensor data of each sensor node of a set of distributed sensor nodes for sensing the sensor data as high-dimensional vectors;
transmitting the high-dimensional vectors over a respective link between a sensor node and a receiver system;
superposing the high-dimensional vectors of the sensor data from the set of sensor nodes by physical superposition, thereby generating a superposed high-dimensional vector; and
classifying the superposed high-dimensional vectors at the receiver system.
